(19) United States
(12) Patent Application Publication
(10) Pub. No.: US 2020/0293165 A1
(43) Pub. Date: Sep. 17, 2020

(54) LANGUAGE SELECTION FOR ELECTRONIC CARD TRANSACTIONS

(71) Applicant: Xerox Corporation, Norwalk, CT (US)

(72) Inventors: Simon J. Gray, Bedford (GB); Veena Kumari Saluja, Welwyn (GB); David Snowball, Sandy (GB); Naveenraj Kaliarajan, Erode (IN)

(73) Assignee: Xerox Corporation, Norwalk, CT (US)

(21) Appl. No.: 16/351,939

(22) Filed: Mar. 13, 2019

(51) Int. Cl. G06F 3/0484; G06F 17/27; G06Q 20/20

(52) U.S. Cl. CPC G06F 3/0484; G06Q 20/20; G06F 17/275

(57) ABSTRACT

An electronic transaction device includes a transaction card reader, which reads information from a transaction card. A language identification component identifies a language preference of a user of the card, based on the information read from the card. A template selection component selects a language template, based on the identified language preference. A user interface generator uses the language template to generate a user interface for display to the user on an associated display device in the preferred language. A user is thus able to select a language for completing a transaction which is not dependent on a location of the electronic transaction device or the card issuer's location.

### BACKGROUND

The exemplary embodiment relates to electronic payment transactions and finds particular application in connection with a system and method which allow a user to perform a transaction in the user's selected language.

Payment cards, such as credit cards, debit cards, ATM cards, and stored value cards, allow users to perform financial transactions, such as cash withdrawal, electronic funds transfer, and the like, at various transaction devices, such as ATMs and point of sale (POS) devices in shops, restaurants, at gas stations, etc. The card readers are electronic devices that can read plastic cards embedded with identifying data in the form of a magnetic strip, computer chip or another storage medium. Card readers may be contact-type or contactless.

In general, when a user pays for an item with a bank or credit card, the card is inserted into the transaction device and the language is assumed the same as that of the vendor. A user who is unfamiliar with the language may have difficulty in interacting with the device or may miss useful information, such as whether a tip has been automatically added.

It would be advantageous for a user to be able to interact with the transaction device in a chosen language.

### INCORPORATION BY REFERENCE

The following references, the disclosures of which are incorporated in their entireties by reference, are mentioned:

U.S. Pat. No. 6,289,315, issued Sep. 11, 2001, entitled CREDIT CARD SWIPE SYSTEM, by Calvi, describes an electronic credit card swipe system for taxis. A voice synthesizer recites the fare in both the local language and a selected one of a number of foreign language options.

US Pub. No. 20090138255A1, published May 28, 2009, entitled CUSTOMER FACING DEVICE HAVING LANGUAGE TRANSLATION CAPABILITIES, by Sterling, et al., describes a customer facing device (CFD) with language translation capabilities. Location information is extracted from the presentation instrument and used to determine a home language.

### BRIEF DESCRIPTION

In accordance with one aspect of the exemplary embodiment, an electronic transaction device includes a transaction card reader which reads information from a transaction card. A language identification component identifies a language preference of a user of the card, based on the information read from the card. A template selection component which selects a language template, based on the identified language preference. A user interface generator uses the language template to generate a user interface for display to the user on an associated display device in the preferred language. A processor which implements the language identification component, template selection component, and user interface generator.

In accordance with another aspect of the exemplary embodiment, a method for conducting a transaction includes reading information from a transaction card, identifying a preferred language of a user of the card, based on the information read from the car, selecting a language template from a plurality of language templates, based on the identified preferred language, and using the selected language template to generate a user interface for display to the user on a display device in the preferred language.

One or more of the steps may be implemented by a processor.

In accordance with another aspect of the exemplary embodiment, a method for conducting a transaction includes providing for a transaction card user to select a preferred language from a plurality of languages. Information is stored on a transaction card or in memory accessible to multiple electronic transaction devices which enables the preferred language to be automatically identified. After storing the information, information is read from the transaction card and the preferred language of the user of the card is identified, based on the information read from the card. A language template is selected from a plurality of language templates, based on the identified preferred language and, the selected language template is used to generate a user interface for display to the user on a display device in the preferred language.

One or more of the steps may be implemented by a processor.

### BRIEF DESCRIPTION OF THE DRAWINGS

FIG. 1 is a functional block diagram of an electronic transaction device in accordance with one aspect of the exemplary embodiment;

FIG. 2 illustrates a payment screen on another transaction device; and

FIG. 3 illustrates a screen of the device of FIG. 1; and

FIG. 4 illustrates a method of performing a transaction in accordance with one aspect of the exemplary embodiment.

### DETAILED DESCRIPTION

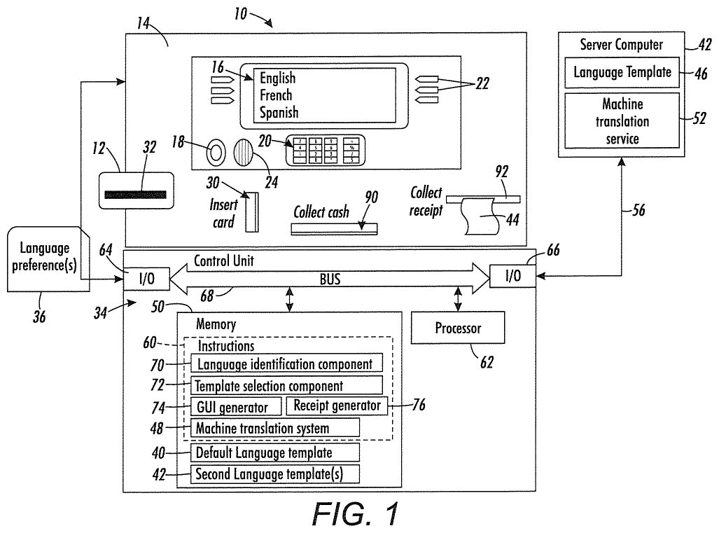

With reference to FIG. 1, a transaction device 10, such as an automated teller machine (ATM), or point of sale (POS) device, is configured for reading information from a payment card 12, such as a credit card, debit card, ATM card, or stored value card, and conducting a financial transaction with a user, such as a payment for goods and/or services, a cash withdrawal, a transfer of funds between user accounts, or the like. The transaction device 10 communicates with the user in a natural language, such as English, French or the like via a user interface device 14. Communication may include visual information (e.g., text, symbols) displayed on a screen 16, aural (spoken) expressions output by a speaker 18, combinations thereof, or the like. The user may interact with the device using a keypad 20, soft buttons 22, touchscreen 16, microphone 24, combination thereof, or the like.

The transaction device 10 includes a card reader 30, such as a slot, touch pad, or the like for reading information that is stored on the payment card 12, e.g. on a magnetic stripe 32, and which may also write information to the payment card, e.g., to the same magnetic stripe 32 or to a different magnetic stripe. The card reader 30 may communicate the information to a control unit 34 via wired or wireless communication. In an exemplary embodiment, the payment card stores (e.g., in the magnetic stripe 32) a language preference 36 (or preferences) or other information from which the user's language preference can be determined. The card reader 30 reads the language preference (or preferences) 36 when the payment card 12 is brought into contact with or is in close proximity to the card reader 30, e.g., in a similar manner to the way in which the card reader 30 reads user information stored on the card, such as a user identifier, such as an account number, user name, expiration date, or combination thereof. In one embodiment, a user identifier incorporates the language preference(s) 36, e.g., as a sequence of digits.

The transaction device 10 may be configured to communicate with users of the device in a first or default mode, using a default language, which may be based on the location of the device, selected by the vendor, or the like. For example, an ATM or POS device located in England may be configured (e.g., with a stored default language template 40) to communicate with a user in English. The transaction device 10 may alternatively or additionally be configured to communicate with users of the device in a second mode, using a user-selected language, which may be deduced from the language preference(s) 36, stored on the payment card 12, or otherwise. For example, an ATM or POS device in England may be configured (e.g., with one or more stored templates 42) to communicate with a user in the user's preferred language, such as French or Spanish. Once the user's preferred language has been identified, all future communications with the user, including a printed receipt 44, may employ the user's preferred language.

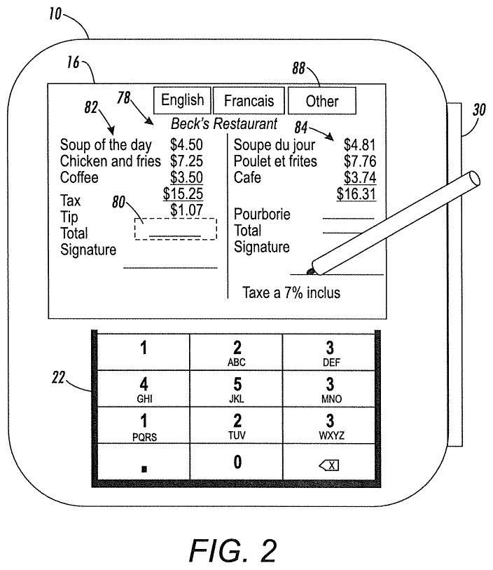

In some instances, the user may be permitted to select more than one preferred language. This may be useful, for example, if the user has some familiarity with the default language and/or does not wish to rely solely on a potentially unreliable translation. In this case, the transaction device may display or otherwise output text/speech in both languages, e.g., side by side, through split screens, or the like, as illustrated in FIG. 2. Similarly, the receipt may 44 be printed in two languages.

In some embodiments, e.g., where transactions are fairly simple, a set of stored templates 40, 42, etc., one for each of a set of different languages, may be stored on the device 10 and/or accessed, as needed from a remote server 46. In other embodiments, for example, where the transaction involves displaying a set of purchased items or services, the transaction device 10 may incorporate a machine translation system 48, e.g., in local memory 50 and/or may access a remote translation service 52. The translation service 52 may be hosted by a remote server, such as server 46, which is accessible to the transaction device 10 via wired or wireless links 56, such as a local area network, or a wide area network, such as the Internet.

In one embodiment, the language preference(s) 36 of the cardholder may be selected prior to activation of the card 12, such that the language preference is prestored on the card when it is issued to the user. The user may be provided with a user interface, for example, on the issuing card's website, where the user selects the language preference(s) 36 prior to issuance of the card.

In another embodiment, the language preference(s) 36 of the cardholder may be selected at activation of the card 12. For example, when telephoning the payment card company to activate the payment card, the user may be prompted to select a preferred language. For example, automated voice recognition or the letter codes on the telephone keypad may be used to select the user's language preference(s). The language preference(s) may subsequently be stored onto the card 12 when the user uses the card at a bank ATM. Alternatively or additionally, the language preference(s) 36 may be stored in remote memory that is accessible to the transaction device 10 and to other transaction devices.

In another embodiment, when the payment card 12 is used at an ATM or other transaction device 10 for the first time, the transaction device may detect that the card is not associated with a preferred language and prompt the user to select a language, e.g., by displaying a set of languages or symbols (e.g., country flags) which the user can click on to select a language. The language preference(s) 36 may then be stored in the card and/or remote memory that is accessible to the transaction device 10 and to other transaction devices. The language selection can thus be similar to selection of a new pin on an ATM device. In the present case, the user may opt to change the language preferences at any time.

In one embodiment, the language may be set by default as that of the card authorizing bank or the address of the user. The user can then change the language and/or add an additional language.

In another embodiment, the language preference may be deduced from the payment card, e.g., based on the location of the issuing bank, which may be encoded in the payment card number. The user can accept the default language or select a different language.

The illustrated electronic transaction device 10 includes various software instructions 60 stored in control unit memory 50, which are executed by an associated processor 62. One or more input/output (I/O) devices 64, 66 allow the control unit 34 to communicate with external devices, such as user interface device 14 and server 46. Hardware components 50, 62, 64, 66 may communicate via a data/control bus 68.

The instructions 60 may include a language identification component 70, a template selection component 72, a user interface generator 74, such as a graphical user interface (GUI) generator, and optionally a receipt generator 76. The language identification component 70 identifies the user's language preferences 36, based on the information 32 stored on the card 12 and may update the information stored on the card if the user inputs a new language preference via the user interface device 14. The template selection component 72 selects an appropriate one or more of the stored templates 40, 46, based on the identified preferences 36. The user interface generator 74 uses the selected template(s) to generate a GUI 78 on the display 16 and populates fields 80 in the display as the user proceeds through a menu of options or otherwise provides inputs (FIG. 2). The receipt generator 76 generates a receipt 44 in physical (e.g., paper) or electronic form summarizing the transaction. As will be appreciated, the instructions may include other instructions for conducting a transaction, securing or making a payment, recording details of the transaction and transmitting them to the card issuer, and the like.

As an example, a person from the UK pays from some food in a restaurant in Spain. Instead of the payment information and bill on the terminal 10 being in Spanish, as soon as the person's card is read, all the information is switched to English. Alternatively, the person can be asked to present their payment card first, as they do to vend fuel, and from that point onwards all the transactions are in the language of the payment card. With the language being stored on the card, or otherwise accessible to multiple transaction devices, the user does not need to select a preferred language each time he or she uses a new transaction device 10.

If the user has selected both Spanish and English, or opts to have the default language displayed as well, the GUI can be a combination of two templates, e.g., in a split screen arrangement with two portions 82, 84 as shown in FIG. 2, allowing the user to interact with either template or use one as informative of the other. The user interface generator 74 may provide a mechanism 88 for a user to change or select preferred languages, e.g., as a set of soft buttons, a drop-down menu, or a speech-to-text converter, which receives a spoken selection of a language and identifies the selected language(s) based thereon. For example, through pressing button 88, the user is able to navigate to a screen which allows language preferences to be set or changed at any time.

The portions 82, 84 of the GUI 78, and also the portions of the receipt 44, in the different languages may be formatted differently, such that the text and layout may not be a simple translation but configured based on local customs in the countries associated with the languages. For example, the prices shown in the French filled template 84 include tax, while those on the English portion 82 have the tax shown separately. Templates for a localized format and content can be retrieved from the server 42 for use in the presentation of the information to the customer. The control unit 34 may also or alternatively produce voice information for the customer, based on the language.

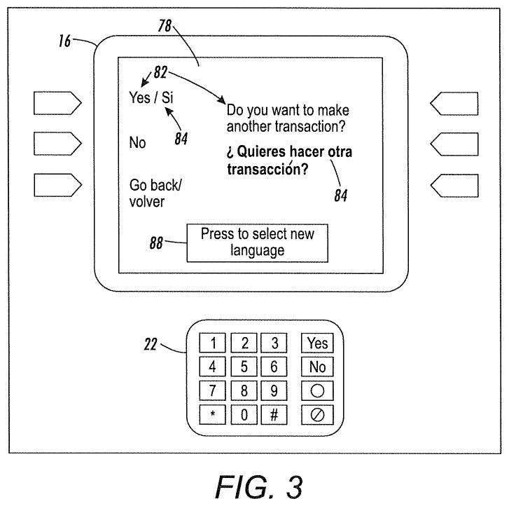

As will be appreciated, the different language portions 82, 84 may be combined or otherwise arranged on the GUI, as illustrated, for example, in FIG. 3.

During operation of the transaction device 10, the I/O interface 64 may communicate with one or more of the display device 16, for displaying information to users, speaker 18, microphone 24, user input device 20, for receiving user selections and other inputs, card reader 30 and other hardware components of the device 10, such as a cash dispenser 90, a receipt printer 92, a dispenser of items or services (e.g., as in a self-service kiosk which displays a set of items for the user to select from or which provides a service, such as printing and/or copying), an item scanner (e.g., as in a grocery store, where barcodes of items to be purchased by a user are scanned), and the like. The network interface 66 allows the computer to communicate with other devices via a computer network, such as a local area network (LAN) or wide area network (WAN), or the internet, and may comprise a modulator/demodulator (MODEM) a router, a cable, and/or Ethernet port.

The control unit 34 may include one or more computing devices, such as a dedicated computing device, a PC, such as a desktop, a laptop, tablet or palmtop computer, a portable digital assistant (PDA), a server computer, a cellular telephone, combination thereof, or other computing device capable of executing instructions for performing the exemplary method.

The memory 50 may represent any type of non-transitory computer readable medium such as random access memory (RAM), read only memory (ROM), magnetic disk or tape, optical disk, flash memory, or holographic memory. In one embodiment, the memory 50 comprises a combination of random access memory and read only memory. In some embodiments, the processor 62 and memory 50 may be combined in a single chip. Memory 50 stores instructions for performing the exemplary method as well as processed data, such as language preferences and transaction details.

The digital processor device 62 can be variously embodied, such as by a single-core processor, a dual-core processor (or more generally by a multiple-core processor), a digital processor and cooperating math coprocessor, a digital controller, or the like. The digital processor 62, in addition to executing instructions 60 may also control the operation of the control unit.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

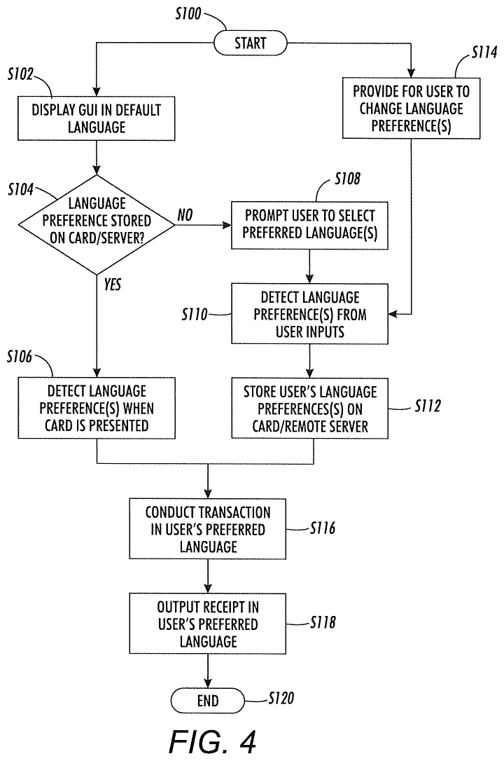

FIG. 4 illustrates a transaction method which may be performed using the device of any one of FIGS. 1 to 3. The method begins at S100.

At S102 a graphical user interface is displayed on a first transaction device 10 in a default language.

If at S104, a user's selected languages are stored on the transaction card 12 or are automatically accessible from a remote server 46 when the card is presented, then at S106, the user's language preference(s) is are/detected from the card/server.

Otherwise, at S108, the user may be provided with a mechanism 88 to select the preferred languages, for example, as a set of language options displayed on the user interface device 14. At S110, the user's language preference(s) is are/detected from the user's inputs and at S112, may be stored to the card or to a remote server accessible to multiple transaction devices for future use on the same or a second transaction device 10.

Once S108-S112 have been performed on one transaction device, these steps can be omitted the next time the card is used on the same or a different transaction device.

In some embodiments, at S114, provision is made for a user to select or change a language preference at the user's discretion, in a similar manner to changing the user's pin. For example, the interface provides for a user to navigate to a menu for “set or change preferred language” through which the user is able to select from a plurality of languages. Using the menu, the user is able to is select or change the language preference(s), e.g., by adding a language preference or preferences and or removing a language preference or preferences. For example, the user may wish to add a language so that receipts can be read by the cardholder's employer or a family member. The method then proceeds to S110, where changes to the user's language preferences are detected and at S112, stored on the user's card or at a remote server.

At S116, a transaction is conducted in the identified language(s).

At S118, a receipt 44 summarizing the transaction may be output in the identified language(s), e.g., in paper or electronic form.

The method ends at S120.

The method illustrated in FIG. 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the control unit 34 (for example, an internal hard drive of RAM), or may be separate (for example, an external hard drive operatively connected with the control unit 34), or may be separate and accessed via a digital data network such as a local area network (LAN) or the Internet (for example, as a redundant array of inexpensive or independent disks (RAID) or other network server storage that is indirectly accessed by the control unit 34 via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 4, can be used to implement the method for conducting a transaction in a preferred language of a card user. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

The device and method find application in a variety retail, kiosk and vending environments. Once the language preferred is selected by the user, the method can proceed without further language inputs from the user in future transactions.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. An electronic transaction device comprising:
a transaction card reader which reads information from a transaction card;
a language identification component which identifies a language preference or a plurality of language preferences of a user of the transaction card, based on the information read from the transaction card;
a template selection component which selects a language template, based on the identified language preference or selects a plurality of language templates based on the plurality of language preferences; and
a user interface generator which uses the language template to generate a user interface for display to the user on an associated display device in the preferred language when the language identification component identifies a single language preference from the information read from the card, or which uses the plurality of language templates to generate the user interface for display to the user on the associated display device in the plurality of preferred languages when the language identification component identifies a plurality of language preferences from the information read from the card; and
a processor which implements the language identification component, template selection component, and user interface generator.

2. The device of claim 1, wherein the information stored on the transaction card includes the language preference or plurality of language preferences.

3. The device of claim 5, wherein when the language preference includes a plurality of language preferences, the user interface generator uses a plurality of language templates to generate the user interface.

4. The device of claim 1, wherein when the language preference includes a plurality of language preferences, the user interface includes a first portion in a first of the plurality of preferred languages and a second portion in a second of the plurality of preferred languages.

5. An electronic transaction device comprising:
a transaction card reader which reads information from a transaction card;
a language identification component which identifies a language preference of a user of the card, based on the information read from the card;
a template selection component which selects a language template, based on the identified language preference;
a user interface generator which uses the language template to generate a user interface for display to the user on an associated display device in the preferred language, wherein the user interface provides a mechanism for enabling a user to select a preferred language and wherein the device stores the selected preferred language to the transaction card; and
a processor which implements the language identification component, template selection component, and user interface generator.

6. (canceled)

7. The device of claim 5, wherein the user interface provides a mechanism for enabling a user to change a preferred language.

8. The device of claim 1, further comprising a receipt generator which generates a receipt that summarizes a transaction in the preferred language.

9. The device of claim 1, further comprising a machine translation system which translates text from a default language to the preferred language to be used by the user interface generator.

10. A method for conducting a transaction comprising:
reading information from a transaction card;
identifying at least one preferred language of a user of the transaction card, based on the information read from the transaction card;
selecting a language template from a plurality of language templates, based on the identified preferred language, wherein when the language preference includes a plurality of language preferences, the method comprises selecting a plurality of the language templates; and
using the at least one selected language template to generate a user interface for display to the user on a display device in the preferred language, wherein when the language preference includes a plurality of language preferences, the method comprises using the plurality of the language templates to generate the user interface.

11. The method of claim 10, wherein the information stored on the transaction card includes the language preference.

12. (canceled)

13. The method of claim 10, wherein when the language preference includes a plurality of language preferences the user interface includes a first portion in a first preferred language and a second portion in a second language.

14. The method of claim 10, further comprising providing for a user to select or change a preferred language.

15. The method of claim 14, further comprising storing the selected language or language change to the transaction card.

16. The method of claim 10, further comprising generating a receipt that summarizes a transaction in the preferred language.

17. (canceled)

18. (canceled)

19. (canceled)
